(19) United States
(12) Patent Application Publication
(10) Pub. No.: US 2008/0033621 A1
(43) Pub. Date: Feb. 7, 2008

(54) VEHICLE TRAVEL CONTROLLER

(75) Inventors: Masahide Nakamura, Yokohama-shi (JP); Yoji Seto, Yokohama-shi (JP); Hidekazu Nakajima, Yokohama-shi (JP)

Correspondence Address: YOUNG & BASILE, P.C., 3001 WEST BIG BEAVER ROAD, SUITE 624, TROY, MI, 48084, US

(73) Assignee: NISSAN MOTOR CO., LTD., Yokohama-shi (JP)

(21) Appl. No.: 11/830,875

(22) Filed: Jul. 31, 2007

(30) Foreign Application Priority Data
Aug. 1, 2006 (JP) 2006-209747
Jun. 27, 2007 (JP) 2007-168900

(51) Int. Cl. B60K 31/00; G01C 21/26

(52) U.S. Cl. 701/65; 701/70

(57) ABSTRACT

A vehicle travel controller for a vehicle comprises a road branching detector configured to detect a branching of a road ahead of the vehicle and a setting device configured to set a target vehicle speed with respect to the road ahead of the vehicle. When road branching is detected ahead of the vehicle, after a primary speed reduction control for a first deceleration a secondary speed reduction control is performed for a second deceleration higher than the first deceleration with respect to the road with a lowest target vehicle speed among various roads at the branching.

### CROSS-REFERENCE TO RELATED APPLICATION

This application claims priority from Japanese Patent Application Ser. No. 2006-209747, filed Aug. 1, 2006, and Japanese Patent Application Ser. No. 2007-168900, filed on Jun. 27, 2007, each of which is incorporated herein in its entirety by reference.

### TECHNICAL FIELD

The present invention pertains to a type of vehicle travel controller.

### BACKGROUND

In a common type of vehicle travel controller, whether the vehicle is traveling correctly on the designated road is judged. When it is judged that the vehicle is traveling on another road instead of the designated road, a warning and an automatic speed reduction control preset for the designated road are turned OFF to prevent the driver from feeling uneasy due to the warning and automatic speed reduction control while the vehicle is traveling on a road different from the designated road. An example of such a vehicle travel controller is shown in Japanese Kokai Patent Application No. 2000-025538.

### BRIEF SUMMARY

Various embodiments of the invention are described herein. One embodiment includes a vehicle travel controller for a vehicle. According to one example, the controller comprises a road branching detector configured to detect a branching of a road ahead of the vehicle, a setting device configured to set a target vehicle speed with respect to the road ahead of the vehicle and a speed control part configured to, when the road branching detector detects branching of the road ahead of the vehicle, perform primary speed reduction control for a first deceleration and perform secondary speed reduction control for a second deceleration after the primary speed reduction control, the second deceleration higher than the first deceleration with respect to a road with a lowest target vehicle speed among plural roads at the branching.

Another example of a vehicle travel controller taught herein comprises means for detecting a branching of a road ahead of the vehicle, means for setting a target vehicle speed with respect to the road ahead of the vehicle and means for performing primary speed reduction control for a first deceleration when the road branching detector detects branching of the road ahead of the vehicle and for performing secondary speed reduction control for a second deceleration after the primary speed reduction control, the second deceleration higher than the first deceleration with respect to a road with a lowest target vehicle speed among plural roads at the branching.

Methods for vehicle traveling control of a vehicle are also taught herein. One embodiment of such a method comprises detecting a presence or absence of branching on a road ahead of the vehicle, performing primary speed reduction control at a first deceleration when the branching is detected and performing secondary speed reduction control for a second deceleration after the primary speed reduction control, the second deceleration higher than the first deceleration with respect to a road with a lowest target vehicle speed among plural roads at the branching.

### BRIEF DESCRIPTION OF DRAWINGS

The description herein makes reference to the accompanying drawings wherein like reference numerals refer to like parts throughout the several views, and wherein:

FIG. 1 is a diagram illustrating the constitution of a vehicle traffic controller according to an embodiment of the disclosure;

FIG. 2 is a flow chart illustrating the operation of a vehicle traffic controller according to an embodiment of the disclosure;

FIG. 3 is a diagram illustrating an example of a flag during route guidance;

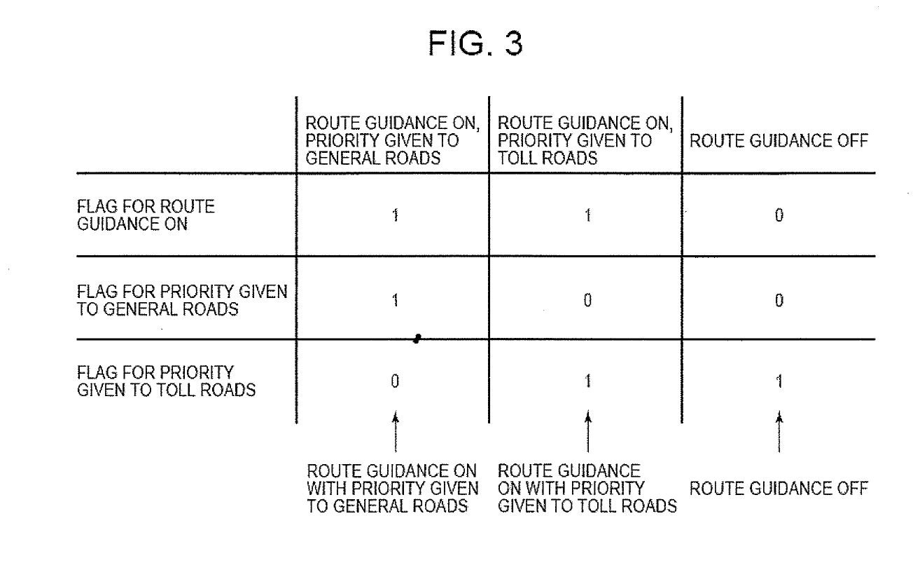

FIG. 4 is a diagram illustrating an example of a method for setting a predicted route;

FIG. 5 is a diagram illustrating an example of a method for setting a predicted route;

FIG. 6 is a diagram illustrating another judgment method for target vehicle speed instruction value change permission;

FIG. 7 is a diagram illustrating another judgment method for target vehicle speed instruction value change permission;

FIG. 8 is a diagram illustrating another judgment method for target vehicle speed instruction value change permission;

FIG. 9 is a diagram illustrating another judgment method for target vehicle speed instruction value change permission;

FIG. 10 is a diagram illustrating another judgment method for target vehicle speed instruction value change permission;

FIG. 11 is a diagram illustrating judgment for initiating a warning;

FIG. 12 is a diagram illustrating judgment for starting a speed reduction control operation;

FIG. 13 is a diagram illustrating an example of a method for changing the target vehicle speed instruction value;

FIG. 14 is a diagram illustrating an example of a method for changing the target vehicle speed instruction value;

FIG. 15 is a diagram illustrating an example of a method for changing the target vehicle speed instruction value;

FIG. 16 is a diagram illustrating an example of a method for changing the target vehicle speed instruction value;

FIG. 17 is a diagram illustrating an example of a method for changing the target vehicle speed instruction value;

FIG. 18 is a diagram illustrating an example of a method for changing the target vehicle speed instruction value;

FIG. 19 is a diagram illustrating an example of a method for changing the target vehicle speed instruction value; and

FIG. 20 is a diagram illustrating an example of a method for changing a warning operation.

### DETAILED DESCRIPTION OF EMBODIMENTS OF THE INVENTION

In these previous vehicle travels controllers, as long as the vehicle is not traveling correctly on the designated road speed reduction control is not performed with respect to approaching curves ahead. This is an undesirable result, In order to prevent this problem, it has been proposed that the course of the vehicle be predicted, and speed reduction control is performed when there is a curve on the predicted course. However, because the predicted course may not be the road taken by the vehicle, speed reduction control may be performed that is different from that for the course desired by the driver. This is also undesirable.

In contrast, a type of vehicle travel controller taught herein sets a target vehicle speed with respect to the road ahead of the vehicle, and the actual vehicle speed is controlled to become the target vehicle speed. When branching of the road ahead of the vehicle position is detected, after primary speed reduction control during a first deceleration, secondary speed reduction control at a second deceleration higher than the first deceleration is performed with respect to the road having the lowest target vehicle speed among the preset target speeds for the various possible roads. Accordingly, when one of the branching roads is a road with a lower target vehicle speed, such as a curve, while the other branching road is a straight road that does not require speed reduction control, it is possible to prevent the performance of rapid speed reduction control that would make the driver feel uneasy even when the vehicle travels on the straight road after branching. This embodiment and other embodiments of the invention are described with reference to the drawing figures.

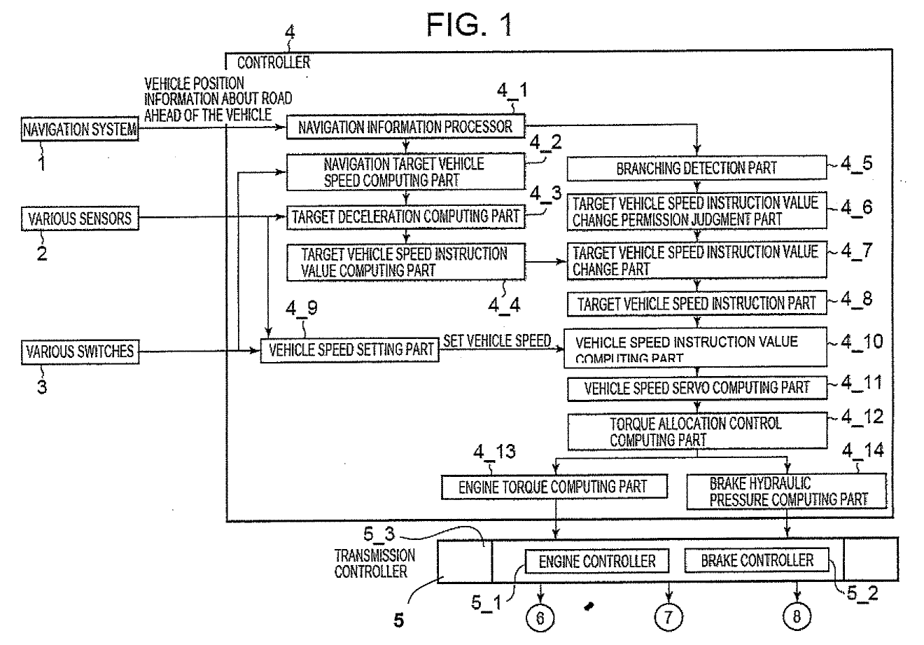

FIG. 1 is a schematic diagram illustrating one such embodiment. Navigation system 1 has a GPS receiver, a road map database, etc. While detecting the vehicle position by means of satellite navigation and inertial navigation, it searches for information pertaining to the nodes of the road on which the vehicle is traveling and outputs the information to controller 4 according to known methods. Various sensors 2 serve to detect the state of the vehicle. They include a sensor for detecting the wheel speed, for example. Various switches 3 are operation switches arranged in the cabin of the vehicle, and they include at least an operation switch for operating embodiments of the travel controller described herein.

Controller 4 is composed of a microcomputer, memory and other peripheral parts, and it performs control of the travel of the vehicle, typically using software stored in memory and operable to perform the functions herein described. More specifically, based on the vehicle position and node information from navigation system 1, controller 4 computes the curvature radius of the curve, and the target vehicle speed for each node is set based on the curvature radius of each node and the preset lateral acceleration. Also, the target deceleration at each node is computed based on the actual vehicle speed computed based on the target vehicle speed for each node and the measurement of the wheel speed. Then, the minimum value is searched from among the target decelerations of the various nodes, and the node as the control object and the target deceleration are set while the target vehicle speed instruction value is computed for reaching the target vehicle speed for the node as the control object.

When navigation system 1 detects that there is a branching road on the road where the vehicle is traveling, controller 4 judges whether the target vehicle speed instruction value has changed. Based on the judgment result, controller 4 computes the speed reduction control quantity for reaching the target vehicle speed instruction value and outputs the quantity to a speed reduction controller 5. Also, controller 4 judges whether there is a branching road ahead of the vehicle by judging whether there is branching information in the information about nodes ahead of the vehicle acquired from navigation system 1. The information about various nodes acquired from navigation system 1 contains a branching number. If the branching number is 0, it is judged that the road is a single road free of branching. If the branching number is 1 or more, it is judged that there are two or more branch roads ahead of the vehicle.

In another embodiment of the disclosure, a camera can be used to take pictures ahead of the vehicle, and road branching is detected by processing the pictures taken. Alternatively, or in addition thereto, radar or the like is used to detect objects ahead of the vehicle, and road branching is detected based on the detection results.

Speed reduction controller 5 makes use of engine controller 5_1 and brake controller 5_2 to perform automatic braking of the vehicle according to the speed reduction control quantity sent from controller 4.

In order to perform the operations described, controller 4 has control blocks, or parts, 4_1 to 4_14 formed in the microcomputer software format. Navigation information processing part 4_1 computes the curvature radius and curvature direction at each node based on the node information acquired from navigation system 1. Target vehicle speed computing part 4_2 sets the target vehicle speed at each node based on the curvature radius at the node. Target deceleration computing part 4_3 computes the target deceleration for meeting the target vehicle speed at each node ahead of the vehicle based on the target vehicle speed at the node and the actual vehicle speed. Target deceleration computing part 4_3 searches for the node with the lowest target vehicle speed among the target vehicle speeds preset for the various roads, and then outputs the lowest target deceleration.

Target vehicle speed instruction value computing part 4_4 computes the target vehicle speed instruction value obtained by adding a limiter of the deceleration variation based on the lowest target deceleration. Branching road detecting part 4_5 detects branching of the road ahead of the vehicle based on the node information acquired from navigation system 1. Target vehicle speed instruction value change permission judgment part 4_6 judges whether the target vehicle speed instruction value is to be changed based on the branching information for the node ahead of the vehicle. Target vehicle speed instruction value changing part 4_7 changes the target vehicle speed instruction value when change in the target vehicle speed instruction value is permitted. Target vehicle speed instruction part 4_8 outputs the vehicle speed instruction value changed based on the branching information or outputs the vehicle speed instruction value that is unchanged.

Vehicle speed setting part 4_9 sets the vehicle speed so as to achieve constant speed traveling based on the operation of the various switches 3 and the actual vehicle speed. For example, when the SET switch is operated while the adaptive cruise control (ACC) main switch among switches 3 is ON, the actual vehicle speed in this case is taken as the set vehicle speed, and the vehicle travels at the constant speed of the set vehicle speed.

Vehicle speed instruction value computing part 4_10 selects the target vehicle speed instruction value or the set vehicle speed, whichever is lower, and outputs it as the vehicle speed instruction value. Vehicle speed servo computing part 4_11 computes the target acceleration/deceleration for reaching the vehicle speed instruction value and outputs it.

Torque allocation control computing part 4_12 determines the allocation of engine torque and brake torque corresponding to the target acceleration/deceleration and outputs the allocation to engine torque computing part 4_13 and brake hydraulic pressure computing part 4_14. According to the allocated engine torque, engine torque computing part 4_13 computes the gear setting of the automatic transmission, the throttle opening and other engine control instruction values and outputs them to engine controller 5 —1 and transmission controller 5_3. On the other hand, brake hydraulic pressure computing part 4_14 computes the brake hydraulic pressure according to the allocated brake torque and outputs it to brake controller 5_2. Engine controller 5_1 controls the throttle opening and air intake system, etc., of engine 6. Transmission controller 5_3 controls the gear setting of automatic transmission 7. Brake controller 5_2 controls the brake hydraulic pressure of friction brake 8, etc.

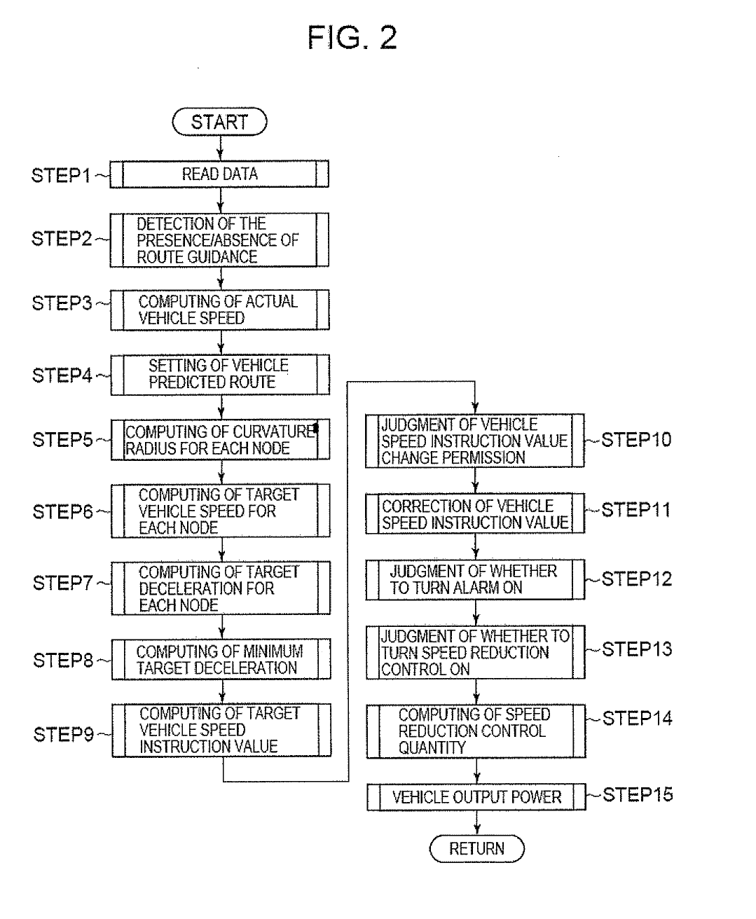

FIG. 2 is a flow chart illustrating the operation in an embodiment of the disclosure performed by controller 4 once every prescribed time period. In step 1, the various types of data are read from sensors 2. More specifically, various wheel speeds Vwi(where i=1 to 4), accelerator openness A, lateral acceleration value Yg*, operation signals for the ACC main switch and SET switch generally attached to the steering wheel, information (Xj, Yj, Lj, Branchj) relative to vehicle position (X, Y) and the various nodes ahead of the vehicle Nj(where j=1 to an integer n) from navigation system 1, route guidance, state route guide, etc., are input. Here, Xj, Yj represent the coordinates of a particular node Nj position, Lj represents the distance between the vehicle position (X, Y) and the node position (Xj, Yj), and Branchj represents the branching number for the node. Also, with regard to the relationships among the various nodes Nj(j=1 to n), the greater the value of j, the farther the node Nj is from the vehicle.

In step 2 navigation system 1 detects whether the target is set and the vehicle is being guided. If the vehicle is being guided a flag for route guidance, flg_route_guide, is set (=1) as shown in FIG, 3. In addition, the priority status of the route is detected. For example, when the route with a general road is given priority, the flag for general road priority, flg_general_route, is set (=1). On the other hand, when the route with a toll highway is given priority, the flag for toll highway priority, flg_highway_route, is set (=1). Here, in the case of the flag for general road priority, flg_general_route=1, the flag for toll highway priority, flg_highway_route, is set at 0, and when the flag for toll highway priority flg_highway_route=1, the flag for general road priority, flg_general_route, is set at 0.

Returning now to FIG. 2, in step 3 the actual vehicle speed V is computed. More specifically, for example, assuming the vehicle to be a rear-wheel-drive type, the actual vehicle speed V as it travels can be computed using the following equation as the average value of the wheel speeds of the front wheels Vw1, Vw2.

V=(Vw1+Vw2)/2 (1)

Also, when ABS control or another system using the vehicle speed is turned ON, the actual vehicle speed (estimated vehicle speed) used in that system can be adopted.

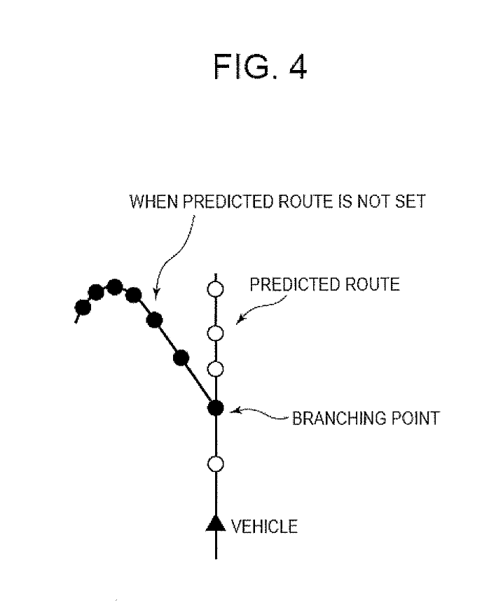

In step 4 a judgment is made on which road will be taken by the vehicle at the branching point based on the node information acquired from navigation system 1. For example, as shown in FIG. 4, based on the various node information acquired from navigation system 1, the direction along the road is taken as the predicted route, When the predicted route is set, the flag indicating route setting, flg_route_set_on, is set (=1). On the other hand, when the predicted route is not set, the curve direction at the branching road is selected each time as shown in FIG. 4.

Returning now to FIG. 2, in step 5 the controller 4 computes the curvature radius Rj at each node Nj based on the node information. There are various methods for computing the curvature radius itself, and the curvature radius can be computed by any method known to those of ordinary skill in the art. In one embodiment, the curvature radius is computed using the commonly adopted 3-point method. As another example, a scheme can also be adopted in which equidistant interpolation points arranged on the road that passes the various nodes and the curvature radius are computed at the interpolation points.

In step 6 the controller 4 computes the target vehicle speed at each node. More specifically, assuming the lateral acceleration Yg* at each node to be 0.3 G, the target vehicle speed Vrj at each node can be computed based on the lateral acceleration Yg* and curvature radius Rj as follows:

Vrj²=Yg* ·|Rj| (2)

According to equation (2), the larger the curvature radius Rj, the higher the target vehicle speed Vrj. Also, a value set by the driver can be used as the lateral acceleration Yg* at each node. Also, setting the target vehicle speed with respect to each node is shown in this embodiment as an example. A scheme can also be adopted in which equidistant interpolation points are arranged on the road that passes the various nodes, and the target vehicle speed is computed at the interpolation points.

In step 7 the controller 4 calculates the target deceleration at each node. The target deceleration Xgsj at each node is computed from actual vehicle speed V, target vehicle speed Vrj at each node and distance Lj between the current position and each node such that:

Xgsj=(V²−Vrj²)/(2·Lj)=(V²−Yg*·|Rj|)/(2·Lj) (3)

In equation (3), the sign for target deceleration Xgsj is positive on the speed reducing side. In this way, target deceleration Xgsj is computed from actual vehicle speed V, target vehicle speed Vrj and distance Lj from the current vehicle position to each node. The lower the target vehicle speed Vrj, the smaller the curvature radius Rj is, or the smaller the distance Lj, the higher the target deceleration Xgsj is. Also, in this example, the distance to each node is used as distance Lj in equation (3). However, a scheme can also be adopted in which equidistant interpolation points are arranged on the road that passes through the various nodes, and the target deceleration is computed at each interpolation point using the distance to the interpolation point.

In step 8, in order to determine the node as the control object from the target deceleration at the various nodes, the lowest target deceleration is detected using the following equation:

Xgs_{—min}=min{Xgsj}; wherein (4)

### Xgs_min is the minimum value of the target deceleration at the various nodes.

The minimum value of the target deceleration Xgs_min is then used in step 9, in which the target vehicle speed instruction value Vrr with the limiter of the variation in the deceleration added to it is computed using the following equation:

Vrr=f{Xgs_min}·t; wherein (5)

t represents time; and
the limiter of the variation amount is 0.01 G/sec, for example.

In step 10 the branching number Branchj for the various nodes Nj is read from the various node information, and a judgment is made on whether a change in the target vehicle speed instruction value is permitted based on the flag for route guidance, flg_route_guide, the flag for a general road being given priority, flg_general_route, the flag for a toll highway being given priority, flg_highway_route, and whether the predicted route is set.

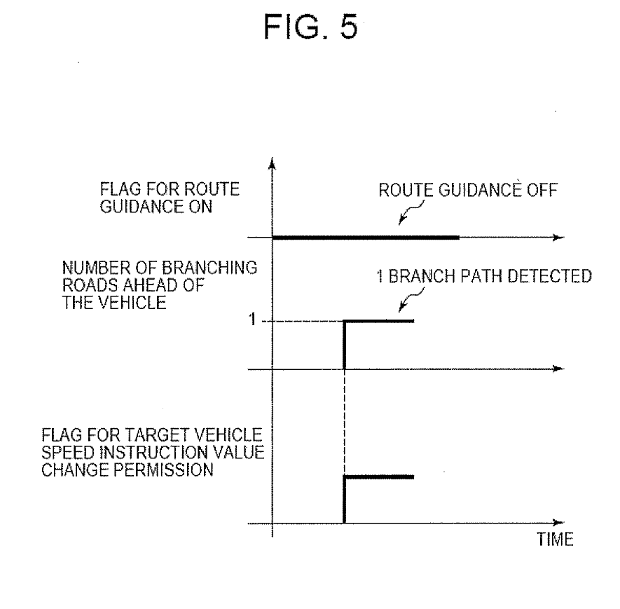

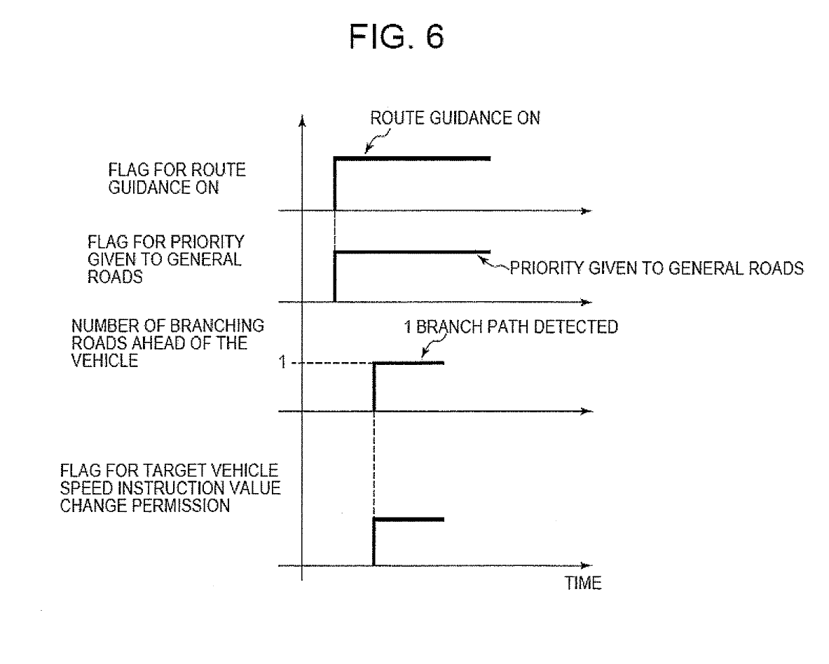

For example, as shown in FIG. 5, when the flag for route guidance flg_route_guide=0, that is, route guidance is off, and branching roads ahead of the vehicle are detected such that the number of branches is greater than 0, the flag for target vehicle speed instruction value change permission, flag_control_chg, is set (=1). Also, as shown in FIG. 6 for example, even when the flag for route guidance flg_route_guide=1, when the flag for general road is given priority flg_general_route=1, and a branching road ahead of the vehicle is detected, the flag can also be set for target vehicle speed instruction value change permission, flag_control_chg (=1). In an additional example, when no predicted route is set with respect to the branching road ahead of the vehicle, that is, when the flag indicating route setting flg_route_set_on=0, the flag can also be set for target vehicle speed instruction value change permission, flag_control_chg (=1).

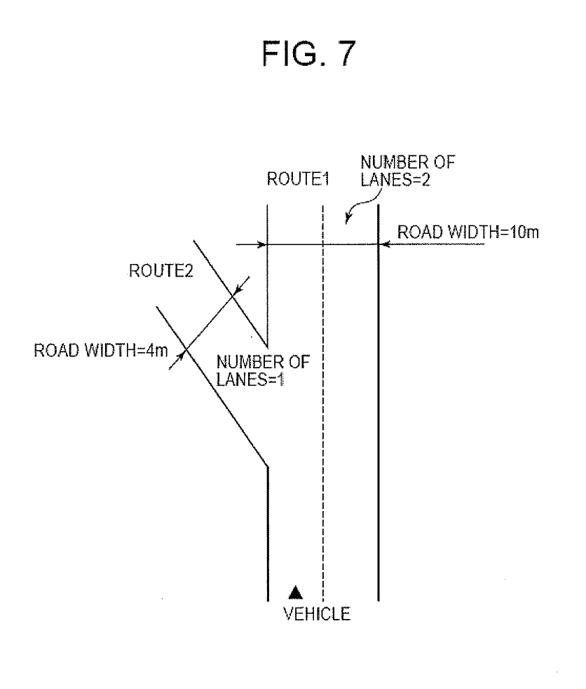

In this described example, whether a target vehicle speed instruction value change is permitted is set depending on whether the vehicle is in the route guidance state. However, a scheme can also be adopted in which whether the target vehicle speed instruction value can be changed is set corresponding to the state of the branching road ahead of the vehicle. For example, irrespective of the value of the flag indicating route setting, flg_route_set_on, the information pertaining to the road state at the branching, such as branching road types, type of link, road width, number of lanes, etc., is read. Then, as shown in FIG. 7, the number of lanes of the straight road and that of the branching road are compared with each other. When the straight road has more lanes, the flag can be set for target vehicle speed instruction value change permission, flag_control_chg (=1). The same is true for the road width. When the straight road is wider, the flag can be set for target vehicle speed instruction value change permission, flag_control_chg (=1).

Also, when it is judged that the lane where the vehicle is traveling is the lane with branching, the flag can be set for target vehicle speed instruction value change permission, flag_control_chg (=1). For example, when the vehicle is traveling in the left-hand lane (or the right-hand lane) on a highway, the flag can be set for target vehicle speed instruction value change permission, flag_control_chg (=1), each time there is an exit from the highway or a branching road to a service area. In addition, the branching road can also be selected as the object of speed reduction control based on the angle (branching angle) of the branching road with respect to the lane where the vehicle is traveling. For example, a road with a branching angle smaller than a prescribed value (±60°) is defined as a branching road where the vehicle may well possibly enter. As a result, a road with a branching angle at the crossing point of ±90° is not taken as a branching road.

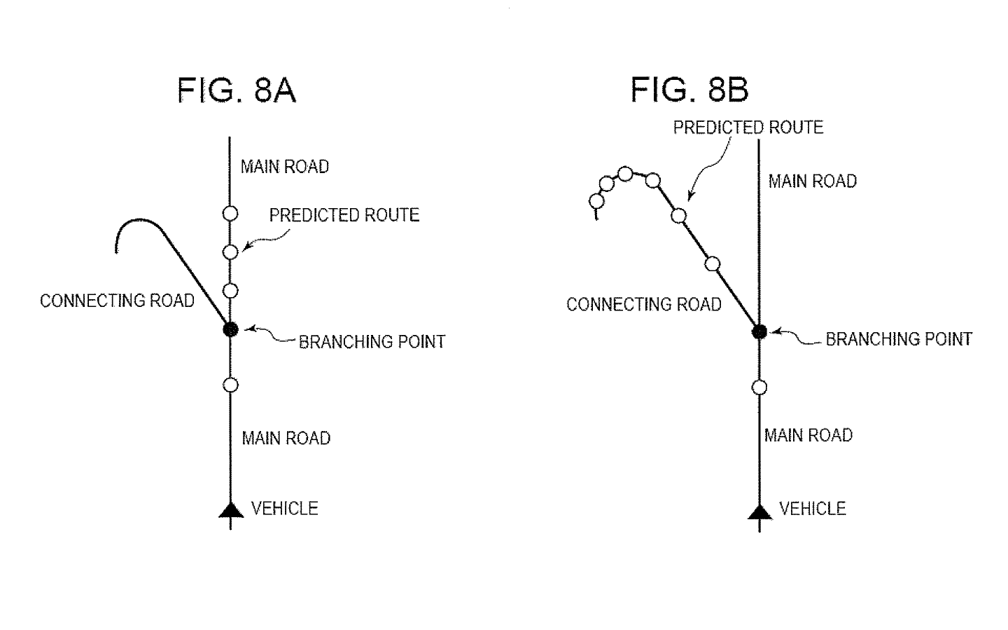

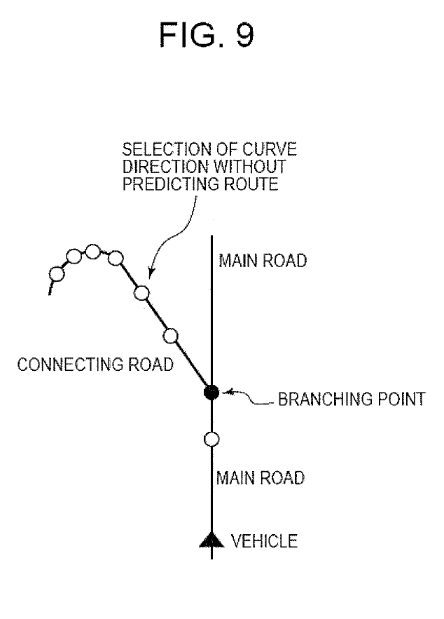

In the above-described example, the target vehicle speed instruction value change permission flag is set irrespective of the value of the route prediction flag. However, a scheme can also be adopted wherein when the flag indicating route setting, flg_route_set_on=1, that is, when route prediction operates, and route prediction causes one road from among the branching roads to be set as the predicted route, as described with reference to FIGS. 8A and 8B. The following operation is performed based on the road types and link types before and after the branching node of the road ahead of the vehicle with road prediction in effect. That is, when the type of road set as the predicted route is identical to or higher in grade than that before branching (see FIG. 8A), the flag for target vehicle speed instruction value change permission, flag_control_chg, is reset (=0). On the other hand, when the type of the road set as the predicted route is lower in grade than that before branching (see FIG. 8B), the flag can be set for target vehicle speed instruction value change permission, flag_control_chg (=1). In addition, instead of setting the target vehicle speed instruction value change permission flag based on the road type and link type, the target vehicle speed instruction value change permission flag can also be set based on the road information, such as the road widths and numbers of lanes before and after the branching point. Also, when the predicted route is not set while the curve direction is selected for each branching road, as shown in FIG. 9, the flag can be set for target vehicle speed instruction value change permission, flag_control_chg (=1), just as described above.

Returning again to FIG. 2, in step 11, when the flag for target vehicle speed instruction value change permission, flag_control_chg, is set (=1), the target vehicle speed instruction value is changed as follows.

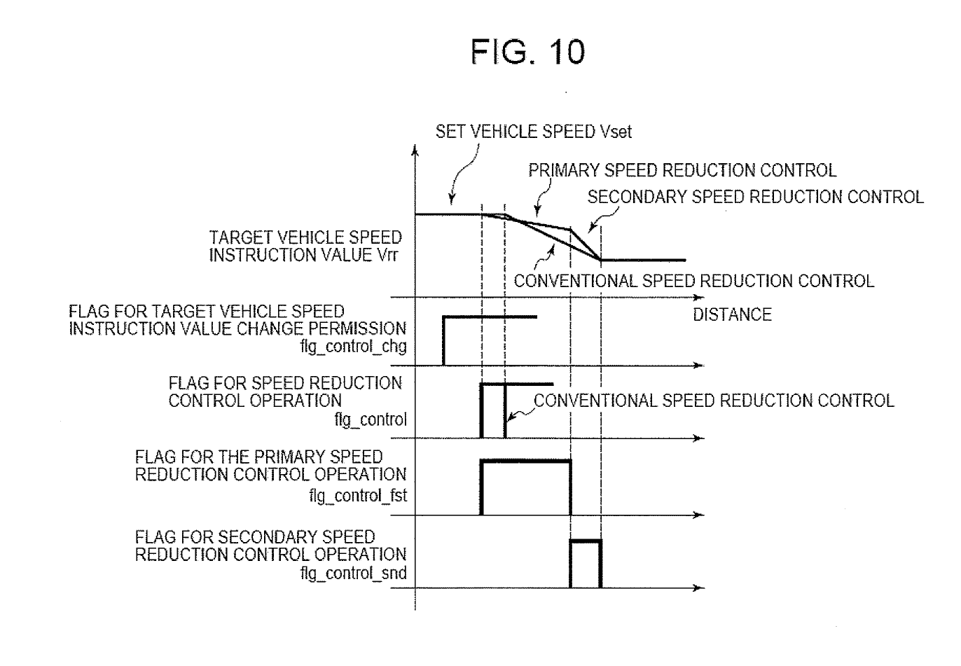

As shown in FIG. 10, target vehicle speed instruction value changing part 4_7 of FIG. 2 performs the following operation. When the flag for target vehicle speed instruction value change permission flag_control_chg, is set (=1), and set vehicle speed Vset=the actual vehicle speed V, if target vehicle speed instruction value Vrr is lower than set vehicle speed Vset (that is, the actual vehicle speed V), the flag for speed reduction control operation, flg_control, is set (=1). First of all, speed reduction is performed such that the driver notices the speed reduction state (primary speed reduction control). Then, when a certain threshold is exceeded, a little higher speed reduction (secondary speed reduction control) is generated for reaching the target vehicle speed for the curve ahead of the vehicle computed from the lateral acceleration set value and the curvature radius so that the target vehicle speed instruction value is changed.

Here, for example, the control quantity in secondary speed reduction control outputs the target vehicle speed instruction value such that it can reach the target vehicle speed, computed from the lateral acceleration set value and the curvature radius, at the same location as in normal operation. Also, when primary speed reduction control is performed, the flag for the primary speed reduction control operation, flg_control_fst, is set (=1), and when secondary speed reduction control is performed, the flag for secondary speed reduction control operation, flg_control_snd, is set (=1).

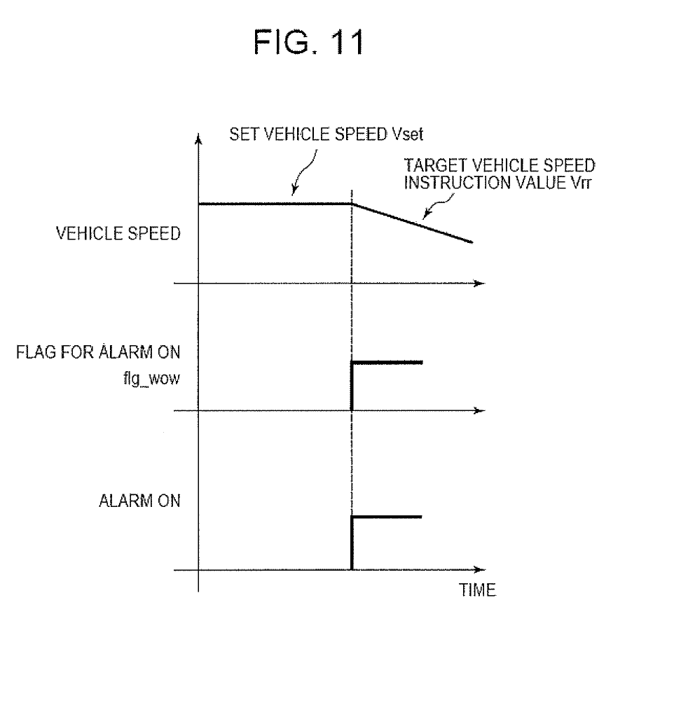

Referring again to FIG. 2, in step 12 a judgment is made on starting the warning operation. For example, the judgment can be made on starting the warning operation based on target vehicle speed instruction value Vrr, actual vehicle speed V and set vehicle speed Vset. For example, when set vehicle speed Vset=actual vehicle speed V, if target vehicle speed instruction value Vrr is lower than set vehicle speed Vset, the warning is activated, and the flag for warning activated, flg_wow, is set (=1) as shown in FIG. 11.

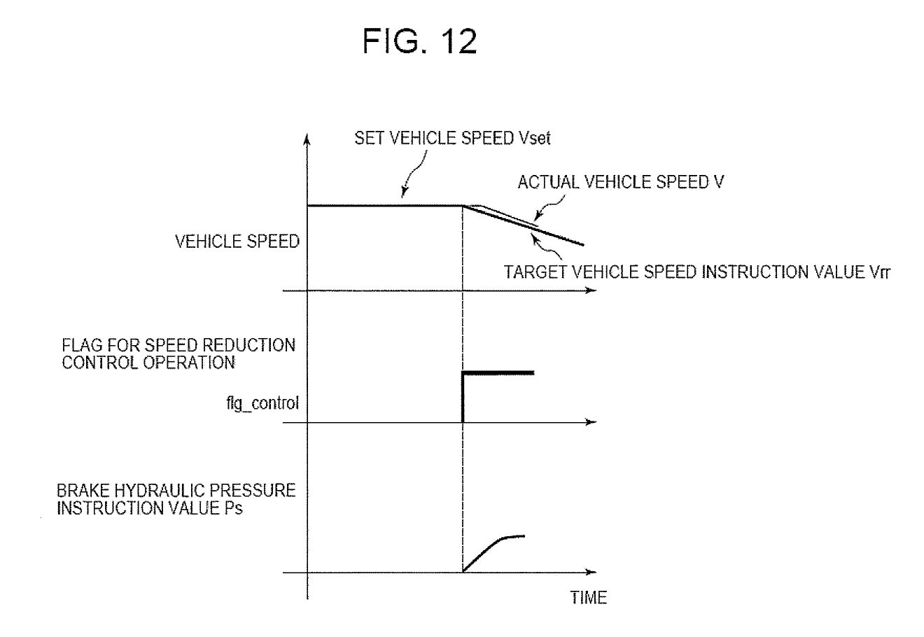

Next, as shown in FIG. 2, in step 13 a judgment is made on starting speed reduction control operation based on target vehicle speed instruction value Vrr, actual vehicle speed V and set vehicle speed Vset. For example, when set vehicle speed Vset=actual vehicle speed V, if target vehicle speed instruction value Vrr is lower than set vehicle speed Vset, the speed reduction control is turned ON, and the flag for speed reduction control operation, flg_control, is set (=1) as shown in FIG. 12.

According to step 14 shown in FIG. 2, a control quantity for reaching target vehicle speed instruction value Vrr is computed. Here, when the flag for speed reduction control operation, flg_control, is set (=1), the target deceleration to reach target vehicle speed instruction value Vrr computed in step 9 is computed by vehicle speed servo computing part 4_11, and torque allocation control computing part 4_12 is used to allocate the engine torque and brake torque corresponding to the target deceleration. Then, the throttle opening instruction value for realizing the allocated engine torque and the brake hydraulic pressure instruction value for realizing the brake torque are output. For example, as shown in FIG. 12, when the flag for speed reduction control operation, flg_control, is set (=1), the brake hydraulic pressure instruction value Ps is output, and the brake control is turned ON.

Referring again to FIG. 2, in step 15 speed reduction and warning control are output to the vehicle. For example, the warning may be performed as a sound or a heads-up display, a navigation screen display, a meter display, an announcement from the navigation system speaker, etc.

In the following, a method for effecting gentle speed reduction control primary speed reduction control) and the threshold for effecting slightly greater speed reduction control (secondary speed reduction control) according to an embodiment of the disclosure is explained. In addition, a method for changing the target vehicle speed instruction value by means of driver intervention and a method for changing warning activated by changing the target vehicle speed instruction value according to another embodiment of the disclosure are explained.

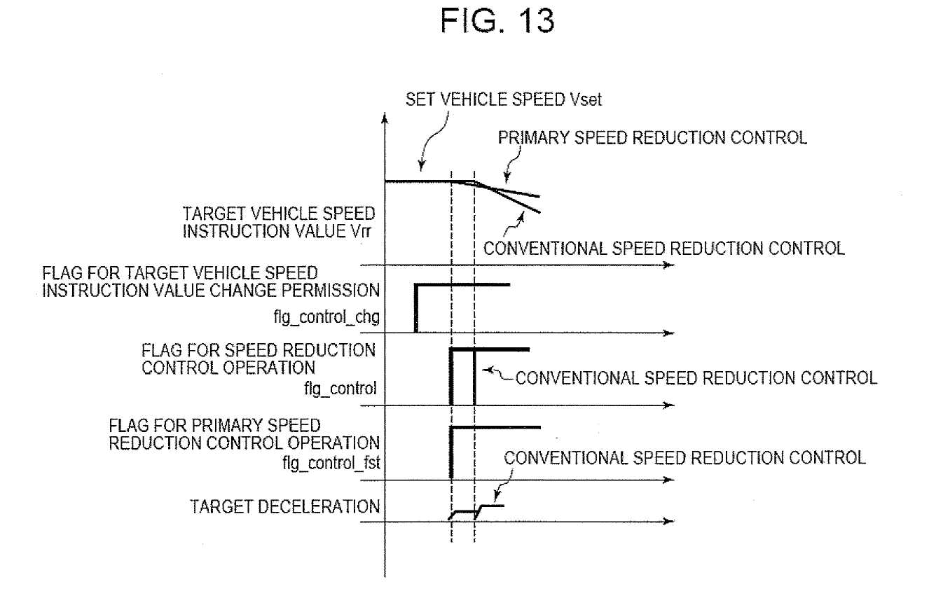

When the flag for target vehicle speed instruction value change permission, flag_control_chg, is set (=1), the maximum value of the target deceleration is reduced when the target vehicle speed instruction value is computed. For example, as shown in FIG. 13, assuming that the target vehicle speed instruction value is computed such that speed reduction is performed at 0.1 G according to conventional control, in this embodiment the target vehicle speed instruction value is computed such that speed reduction is performed at 0.05 G. Also, in the example described above, the target deceleration is changed in order to change the target vehicle speed instruction value. However, the slope of the limiter of the change amount can also be changed when the target vehicle speed instruction value is computed. For example, the slope can be changed from 0.05 G/sec to 0.01 G/sec. In this way, it is possible to gradually perform the primary speed reduction control starting immediately. As a result, when unnecessary speed reduction control is turned ON, the driver soon notices it and can then release the speed reduction and other operations easily. Also, because the amount of speed reduction is small, traffic flow disturbance on the road can be reduced when the driver releases the control.

When the flag for target vehicle speed instruction value change permission, flag_control_chg, is set (=1), the lateral acceleration set value Yg* may be high. That is, when the flag flag_control _chg is set (=1), for example, the lateral acceleration set value may be changed from 0.25 G to 0.35 G. Then, when set vehicle speed Vset actual vehicle speed V, as target vehicle speed instruction value Vrr becomes lower than set vehicle speed Vset, both the flag for speed reduction control operation, flg_control, and the flag for primary speed reduction control operation, flg_control_fst, are set (=1). Then, primary speed reduction control is turned ON with a timing slower than that in conventional control. In this way, it is possible to delay the primary speed reduction control ON start timing relative to the timing for performing normal speed reduction control (or to have the same timing).

When the flag for target vehicle speed instruction value change permission, flag_control_chg, is set (=1), the speed reduction control can be performed by means of brake control using the friction brake or by means of a downshift by the automatic transmission or torque-down (throttle shut-off or the like) of the engine.

In the following, the threshold for performing secondary speed reduction control after primary speed reduction control according to an embodiment of the disclosure is explained.

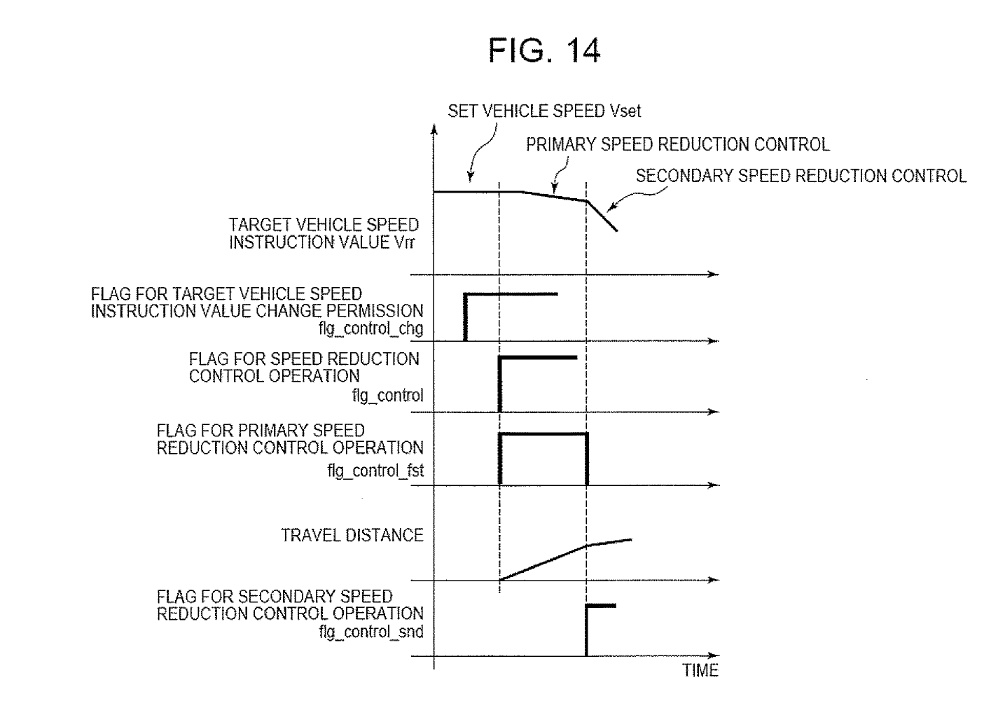

As shown in FIG. 14, the traveling distance of the vehicle is computed when the flag for target vehicle speed instruction value change permission, flag_control_chg, is set (=1) and also both the flag for speed reduction control operation, flg_control, and the flag for primary speed reduction control operation, flg_control_fst, are set (=1) to perform the primary speed reduction control. Then, when it is judged that the vehicle has traveled a prescribed distance, for example, 100 m, after the primary speed reduction control was turned ON, secondary speed reduction control operation, flg_control_snd, is set (=1), and the target vehicle speed instruction value is changed such that the secondary speed reduction control is performed. Also, as described above, secondary speed reduction control is turned ON after traveling a prescribed distance after the primary speed reduction control was turned ON.

Alternatively, a scheme can also be adopted in which secondary speed reduction control is turned ON after traveling for a prescribed time after primary speed reduction control was turned ON. In this way, by using a prescribed elapsed time since primary speed reduction control was turned ON as the threshold for turning ON secondary speed reduction control, it is possible to perform speed reduction such that the driver does not notice the speed reduction. Then, speed reduction is performed with secondary speed reduction control to reach the target vehicle speed with respect to the curve ahead of the vehicle.

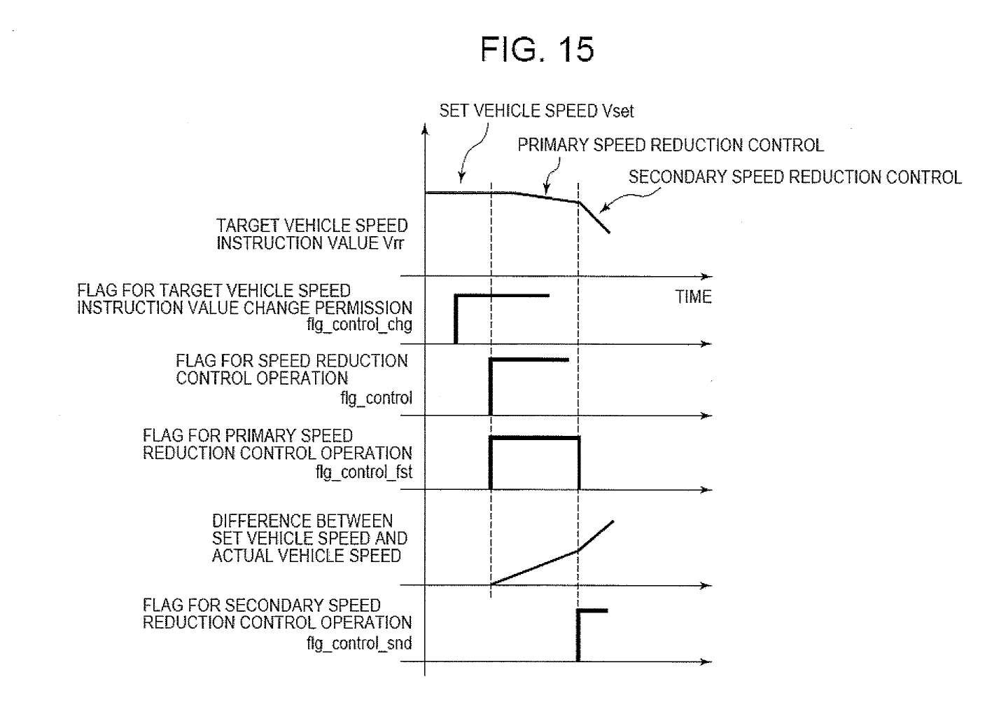

FIG. 15 is a diagram illustrating another example. When the flag for target vehicle speed instruction value change permission, flag_control_chg, is set (=1), and both the flag for speed reduction control operation, flg_control, and the flag for primary speed reduction control operation, flg_control_fst, are set (=1), primary speed reduction control is turned ON. Then, a judgment is made on whether the vehicle has decelerated to the prescribed vehicle speed. That is, the difference between the vehicle speed before the primary speed reduction control and the actual vehicle speed is computed, and the target vehicle speed instruction value is changed such that if the difference in the vehicle speed exceeds a prescribed value, for example 5 km/h, the flag for secondary speed reduction control operation, flg_control_snd, is set (=1). Accordingly, secondary speed reduction control is turned ON. In this way, by making the threshold for turning ON secondary speed reduction control be that the difference from the vehicle speed before performing primary speed reduction control exceeds a prescribed value, it becomes possible to perform speed reduction such that the driver can notice it. In addition, the secondary speed reduction control performed after that, it permits reaching the target vehicle speed with respect to the curve ahead of the vehicle.

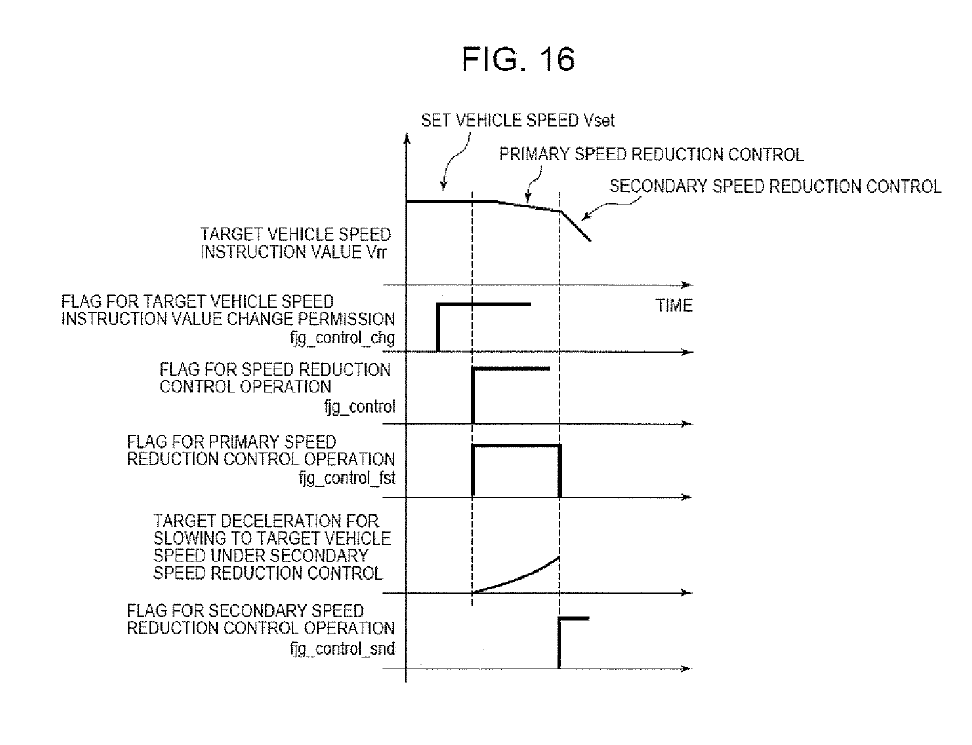

FIG. 16 is a diagram illustrating another example. In this case, the flag for target vehicle speed instruction value change permission, flag_control_chg, is set (=1), and both the flag for speed reduction control operation, flg_control, and the flag for primary speed reduction control operation, flg_control_fst, are set (=1) so that primary speed reduction control is turned ON. A judgment is then made on whether the target deceleration for reaching the target vehicle speed at the curve ahead of the vehicle computed from the lateral acceleration set value and the curvature radius is higher than a prescribed value. For example, as an implementation of one embodiment, when the primary speed reduction control is a gentle speed reduction control, secondary speed reduction control represents a higher deceleration compared to normal speed reduction control. Consequently, in primary speed reduction control, the target deceleration needed to reach the target vehicle speed at the curve ahead of the vehicle, computed from the lateral acceleration set value and the curvature radius by the secondary speed reduction control, is gradually raised. As a result, when it is judged that the necessary target deceleration exceeds a prescribed value, for example 0.15 G, the target vehicle speed instruction value is changed such that flag for secondary speed reduction control operation, flg_control_snd_on, is set (=1), and secondary speed reduction control is turned ON. In this way, when the target deceleration needed in secondary speed reduction control exceeds a prescribed value, the threshold for turning ON secondary speed reduction control can delay secondary speed reduction control to the lowest level. Also, because the speed reduction control is inappropriate, the driver can easily notice it. In addition, in the secondary speed reduction control performed after that it is possible to perform speed reduction to reach the target vehicle speed with respect to the curve ahead of the vehicle.

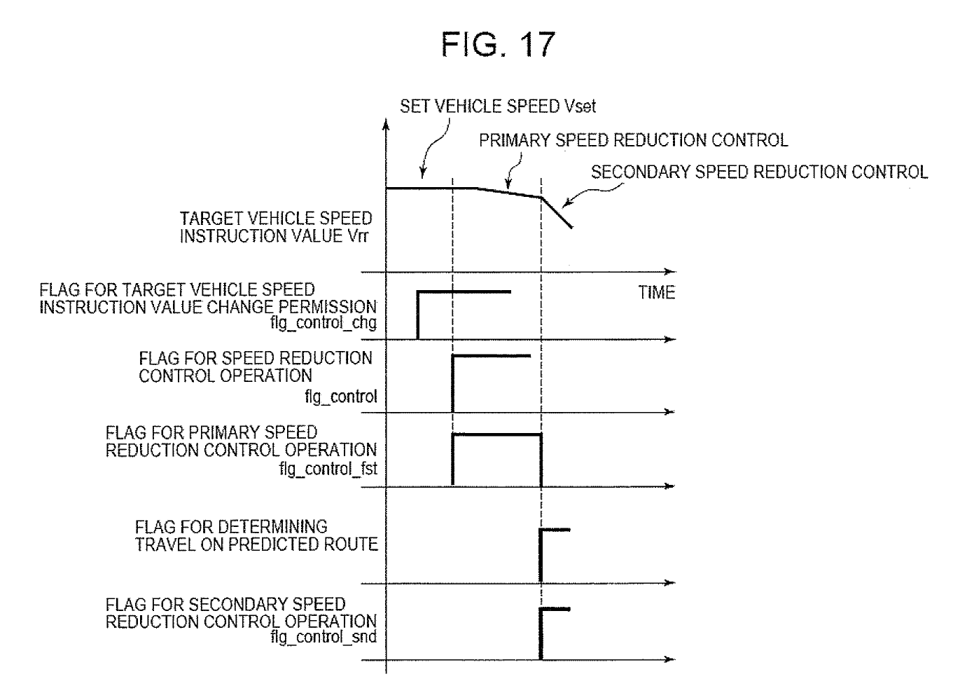

FIG. 17 shows another example. In this example, the flag for target vehicle speed instruction value change permission, flag_control_chg, is set (=1), and both the flag for speed reduction control operation, flg_control, and the flag for primary speed reduction control operation, flg_control_fst, are set (=1). The primary speed reduction control is turned ON. Then, when it is judged that this speed reduction control is ON from the steering angle, yaw rate, blinker operation, camera, etc., it is predicted that the vehicle is approaching a curve. Further, if it is judged that the vehicle is not outside the predicted route, the flag for secondary speed reduction control operation, flg_control_snd is set (=1), and the target vehicle speed instruction value is changed so that secondary speed reduction control is turned ON. Here, as an example according to one embodiment, secondary speed reduction control is turned ON when it is determined that the vehicle is not outside the predicted route. In another embodiment, a scheme can also be adopted in which primary speed reduction control is terminated when it is determined that the vehicle is outside the predicted route.

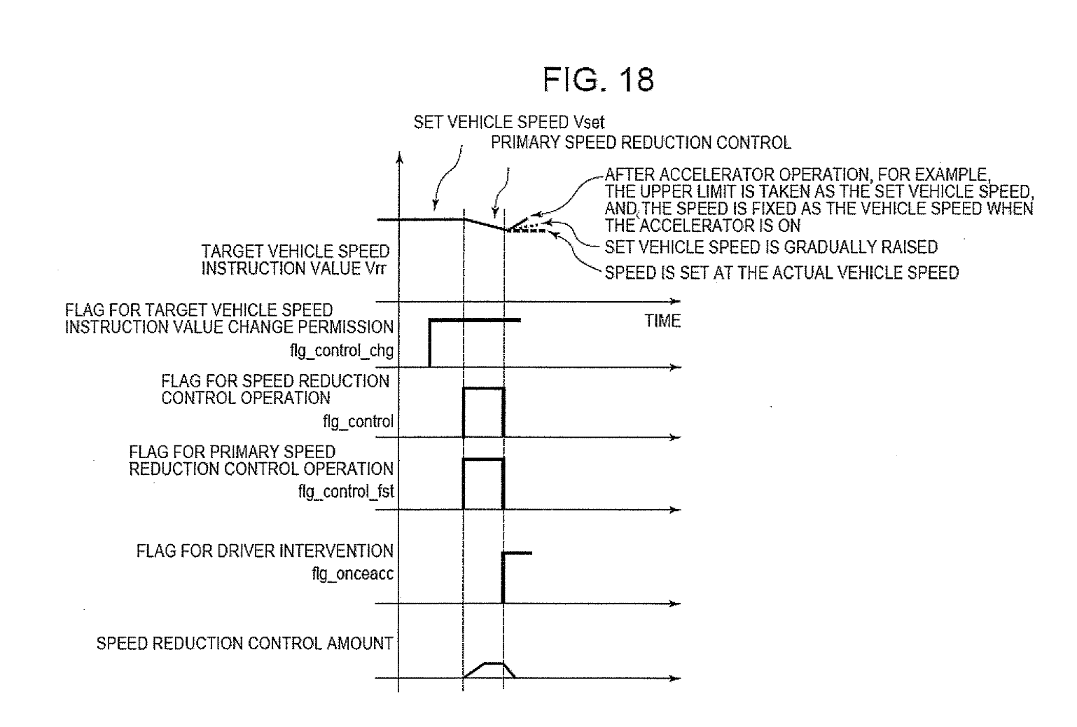

In the following, a method for changing the target vehicle speed instruction value is explained with respect to intervention by the driver, such as operation of the accelerator by the driver. As shown in FIG. 18, the flag for target vehicle speed instruction value change permission, flag_control_chg, is set (=1), and both the flag for speed reduction control operation, flg_control, and the flag for primary speed reduction control operation, flg_control_fst, are set (=1) to perform primary speed reduction control. Then, when the driver operates the accelerator in this example, the flag for driver intervention, flg_onceacc, is set (=1), and speed reduction control is terminated. Corresponding to the driver's operation of the accelerator, the target vehicle speed instruction value is gradually changed to the preset vehicle speed. In previous examples, returning to the set vehicle speed is performed gradually. However, as shown in FIG. 18, a scheme can also be adopted in which the vehicle speed is fixed at the target vehicle speed instruction value when the accelerator is pressed down, or the actual vehicle speed can be taken as the target vehicle speed instruction value. Also, if the accelerator is released when the actual vehicle speed has exceeded the set vehicle speed due to accelerator operation by the driver, the upper limit of the target vehicle speed instruction value is taken as the set vehicle speed.

When the driver steps on the accelerator during speed reduction control, and then releases it, and the curve ahead of the vehicle has not been passed, the vehicle is decelerated to the set vehicle speed if the actual vehicle speed is higher than the set vehicle speed. In contrast, the vehicle speed when the accelerator is released is taken as the target vehicle speed instruction value if the actual vehicle speed is lower than the set vehicle speed. That is, speed reduction control is terminated at the time that the accelerator is operated, and the vehicle then runs at a constant speed equal to the target vehicle speed instruction value. Another scheme can also be adopted whereby speed reduction control is terminated when the driver operates the accelerator, but when the difference between the target vehicle speed computed from the lateral acceleration set value and the curvature radius and the target vehicle speed instruction value exceeds a prescribed value when the accelerator is released, the target vehicle speed instruction value is changed so that speed reduction control is turned ON. In addition, a scheme can also be adopted in which the primary speed reduction control is not started if the driver has already operated the accelerator before entering speed reduction control.

In this way, by terminating speed reduction control upon operation of the accelerator by the driver, it is possible to reduce driver uneasiness when inappropriate speed reduction control is performed. Also, the target vehicle speed instruction value rises to the set vehicle speed corresponding to the accelerator operation by the driver, and then the target vehicle speed instruction value is taken to be the vehicle speed when the accelerator is released. As a result, the vehicle can run at a constant speed, and it is possible to prevent the speed reduction control operation.

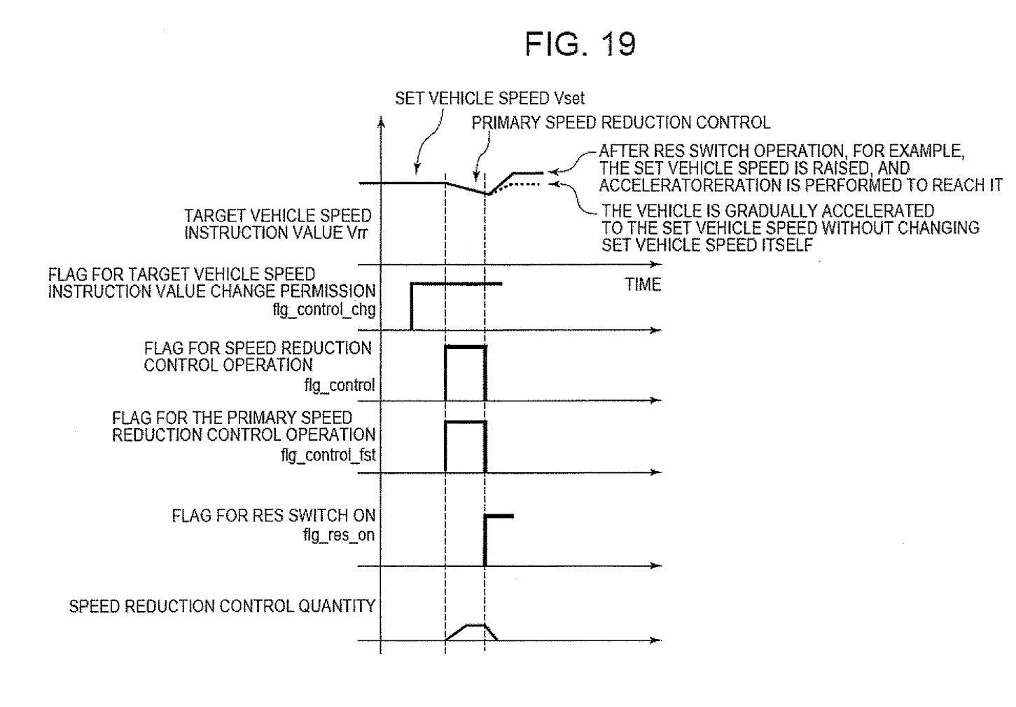

As another example, besides accelerator operation by the driver, the driver can operate switches. In the following, the method is explained for changing the target vehicle speed instruction value with respect to such switch operation by the driver. As shown in FIG. 19, the flag for target vehicle speed instruction value change permission, flag_control_chg, is set (=1), and both the flag for speed reduction control operation, flg_control, and the flag for primary speed reduction control operation, flg_control_fst, are set (=1 ). Then, when the driver presses the resume switch (hereinafter to be referred to as the RES switch) among the various types of switches 3, the flag for RES switch ON, flag_res_on, is set (=1). Speed reduction control is terminated. Also, when the driver presses the RES switch, the vehicle speed set by the driver can be changed from, for example, 80 km/h to 85 km/h. Then the target vehicle speed instruction value is gradually changed to 85 km/h.

In this embodiment the set vehicle speed is increased when the RES switch is pressed. However, in other embodiments a scheme can also be adopted in which when, for example, the speed reduction control ON flag is set, the target vehicle speed instruction value is changed to become the set vehicle speed without a change in the set vehicle speed. More specifically, when the set vehicle speed is at 80 km/h, the speed reduction control is turned ON, and when the driver presses the RES switch, the set vehicle speed is kept as is at 80 km/h while the target vehicle speed instruction value is gradually changed to the set vehicle speed, that is, 80 km/h.

In this way, as speed reduction control is terminated due to operation of a switch by the driver, it is possible to reduce driver uneasiness when inappropriate speed reduction control is turned ON. Also, when the driver presses the switch, the set vehicle speed is not changed and the target vehicle speed instruction value is taken as the set vehicle speed, or the set vehicle speed is increased by 1 setting, so that the vehicle is accelerated to the set vehicle speed before speed reduction or to the newly set vehicle speed.

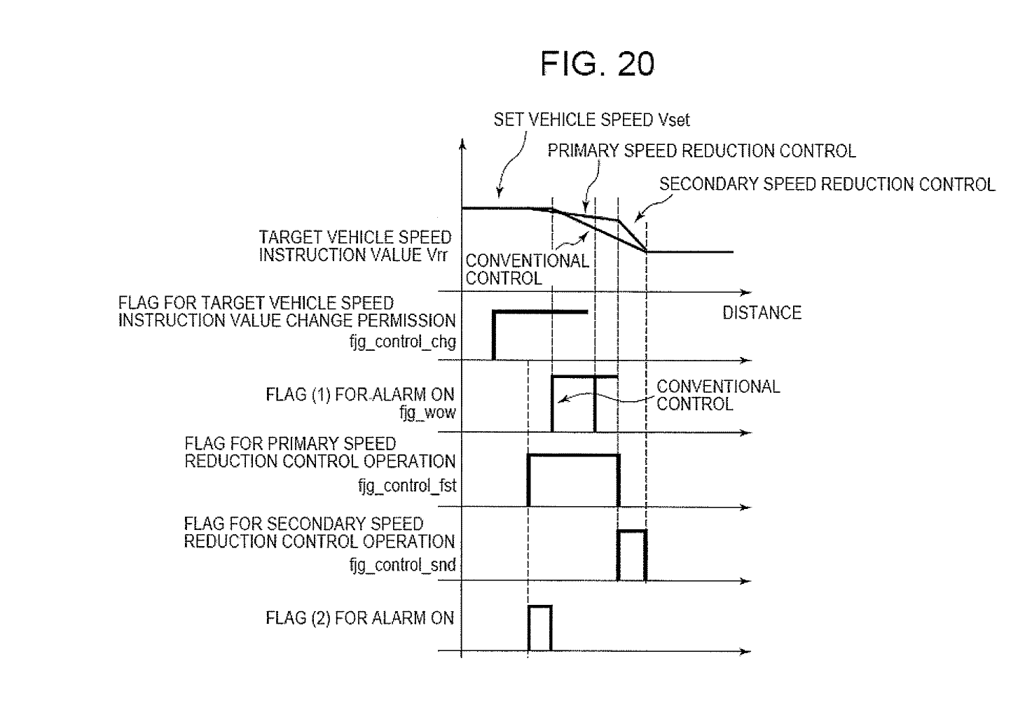

In the following, a method is explained for changing a warning activated when a target vehicle speed instruction value change is permitted. As shown in FIG. 20, when the flag for target vehicle speed instruction value change permission, flag_control_chg, is set (=1), the flag for a warning activated timing change, flg_wow_chg, is set (=1). Then, both the flag for speed reduction control operation, flg_control, and the flag for primary speed reduction control operation, flg_control_fst, are set (=1), and primary speed reduction control is turned ON. After that, 1 sec before secondary speed reduction control is turned ON, a warning, such as “Curve ahead” or “Reduce speed,” is issued. In this example, the warning is activated 1 sec before the secondary speed reduction control is turned ON. However, a scheme can also be adopted in which the warning is activated after a prescribed time elapses after primary speed reduction control was turned ON. Also, one may adopt a scheme in which the warning is activated after traveling a prescribed distance. In addition, a scheme can also be adopted in which the warning is activated when the difference between the set vehicle speed and the actual vehicle speed exceeds a prescribed value, or the target deceleration for reducing the speed to the target vehicle speed in secondary speed reduction control exceeds a prescribed value.

In this example, the warning is issued as an announcement from a speaker of navigation system 1. However, it can also be issued by a buzzer, a meter display, a navigation screen display, a heads-up display, or any other form that can provide the warning information to the driver.

A scheme can also be adopted in which while primary speed reduction control is performed, the message “Branching ahead” is announced. In this way, while primary speed reduction control is performed, a warning of “Branching ahead” or the like is announced so that the driver can easily handle a situation in which inappropriate speed reduction control is turned ON. In a conventional travel controller, because a warning is issued when primary speed reduction control is turned ON, it is difficult for the driver to determine which curve ahead requires deceleration. In the present embodiment the warning of “Curve ahead” is announced before secondary speed reduction control, so that it is possible to avoid possible driver confusion due to too early a warning.

As explained above, according to certain embodiments, when a branching road ahead of the vehicle is detected by the navigation system, and speed reduction control is turned ON, by performing primary speed reduction control such that the driver does not notice it, it is still possible to avoid a warning or inappropriate speed reduction control that makes the driver notice it even when the vehicle enters a route different from the predicted route, and it is possible to travel with the traffic flow without a significant drop in the vehicle speed. On the other hand, when the vehicle follows the predicted route, it is possible by means of secondary speed reduction control to reduce the vehicle speed to the target vehicle speed as it passes the branching road so that the operation assisting effect can be realized with high reliability. In addition, because speed reduction control is terminated due to driver intervention, it is possible to alleviate driver unease due to inappropriate speed reduction control.

Also, according to certain embodiments, a warning is issued after the start of primary speed reduction control. As a result, the driver can easily handle a situation in which inappropriate speed reduction control is turned ON. In addition, because the warning is issued after the start of secondary speed reduction control, the warning is issued at an appropriate location.

Also, in embodiments described herein, the precondition is that speed reduction control is performed when branching of the road ahead of the vehicle is detected while traveling according to the preset vehicle speed. However, the present invention is not limited to this. For example, a scheme can also be adopted in which speed reduction control is performed while the driver operates of the accelerator. In this case, the requested driving torque corresponding to the accelerator operation by the driver can be reflected in the speed reduction control.

Also, in the speed reduction control described herein, the operation is performed with respect to the curve ahead of the vehicle. However, the present invention is not limited to this. For example, it can also be adopted for speed reduction control for a restricted speed corresponding to the specific road type, or school zone, slope, or other area where the vehicle should travel slowly.

In addition, the branching is not limited to situations with two branching roads. The present invention can also be adopted in a situation in which there are three or more branching roads. That is, stepwise speed reduction control consisting of primary speed reduction control and secondary speed reduction control can be performed for the road among the various branching roads with the lowest target vehicle speed (that is, the road with the highest target deceleration).

Accordingly, the above-described embodiments have been described in order to allow easy understanding of the invention and do not limit the invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A vehicle travel controller for a vehicle, comprising:
a road branching detector configured to detect a branching of a road ahead of the vehicle;
a setting device configured to set a target vehicle speed with respect to the road ahead of the vehicle; and
a speed control part configured to, when the road branching detector detects branching of the road ahead of the vehicle, perform primary speed reduction control for a first deceleration and perform secondary speed reduction control for a second deceleration after the primary speed reduction control, the second deceleration higher than the first deceleration with respect to a road with a lowest target vehicle speed among plural roads at the branching.

2. The vehicle travel controller according to claim 1 wherein the speed control part is further configured to perform the primary speed reduction control by signaling a downshift of an automatic transmission of the vehicle.

3. The vehicle travel controller according to claim 1 wherein the speed control part is further configured to perform the primary speed reduction control by signaling a friction brake of the vehicle.

4. The vehicle travel controller according to claim 1 wherein the speed control part is further configured to perform the primary speed reduction control by signaling a torque-down of an engine of the vehicle.

5. The vehicle travel controller according to claim 1 wherein the speed control part is further configured to start the secondary speed reduction control after a prescribed time elapses or after a prescribed traveling distance passes since a start of the primary speed reduction control.

6. The vehicle travel controller according to claim 1 wherein the speed control part is further configured to start the secondary speed reduction control when a difference between a vehicle speed before a start of the primary speed reduction control and a vehicle speed after the start of the primary speed reduction control exceeds a prescribed value.

7. The vehicle travel controller according to claim 1 wherein the speed control part is further configured to start the secondary speed reduction control when an input from a navigation device of the vehicle indicates that the vehicle has passed the road branching and is traveling on the road with the lowest target vehicle speed.

8. The vehicle travel controller according to claim 1 wherein the speed control part is further configured to terminate the primary speed reduction control and the secondary speed reduction control when operation of an accelerator of the vehicle is detected.

9. The vehicle travel controller according to claim 1, further comprising:
an input configured to receive a signal from a resume switch operable to start constant speed traveling control wherein the vehicle runs at a preset constant vehicle speed; and wherein the speed control part is further configured to terminate the primary speed reduction control and the secondary speed reduction control when operation of the resume switch is detected.

10. The vehicle travel controller according to claim 1, further comprising:
a warning part configured to signal a warning when the secondary speed reduction control is started.

11. The vehicle travel controller according to claim 1 wherein the road branching detector is further configured to detect the branching of the road ahead based on a relationship between road types of the plural roads and a type of road on which the vehicle is traveling.

12. The vehicle travel controller according to claim 1 wherein the road branching detector is further configured to detect the branching when a second road forms an angle smaller than a prescribed angle with a first road on which the vehicle is traveling.

13. A vehicle travel controller for a vehicle, comprising:
means for detecting a branching of a road ahead of the vehicle;
means for setting a target vehicle speed with respect to the road ahead of the vehicle; and
means for performing primary speed reduction control for a first deceleration when the road branching detector detects branching of the road ahead of the vehicle and for performing secondary speed reduction control for a second deceleration after the primary speed reduction control, the second deceleration higher than the first deceleration with respect to a road with a lowest target vehicle speed among plural roads at the branching.

14. A method for vehicle traveling control of a vehicle, the method comprising.
detecting a presence or absence of branching on a road ahead of the vehicle;
performing primary speed reduction control at a first deceleration when the branching is detected; and
performing secondary speed reduction control for a second deceleration after the primary speed reduction control, the second deceleration higher than the first deceleration with respect to a road with a lowest target vehicle speed among plural roads at the branching.

15. The method according to claim 14 wherein performing the primary speed reduction control further comprises at least one of signaling a downshift of an automatic transmission of the vehicle, signaling a friction brake of the vehicle and signaling a torque-down of an engine of the vehicle.

16. The method according to claim 14, further comprising:
starting the secondary speed reduction control after a prescribed time elapses or after a prescribed traveling distance passes after a start of the primary speed reduction control.

17. The method according to claim 14, further comprising:
starting the secondary speed reduction control when a difference between a vehicle speed before starting the primary speed reduction control and a vehicle speed after starting the primary speed reduction control exceeds a prescribed value.

18. The method according to claim 14, further comprising:
starting the secondary speed reduction control when an input from a navigation device of the vehicle indicates that the vehicle has passed the road branching and is traveling on the road with the lowest target vehicle speed.

19. The method according to claim 14, further comprising:
detecting operation of an accelerator of the vehicle; and
terminating the primary speed reduction control and the secondary speed reduction control after detecting the operation.

20. The method according to claim 14, further comprising:
receiving a signal from a resume switch operable to start constant speed traveling control wherein the vehicle runs at a preset constant vehicle speed; and
terminating the primary speed reduction control and the secondary speed reduction control after receiving the signal.
